(19) United States
(12) Patent Application Publication
(10) Pub. No.: US 2013/0029083 A1
(43) Pub. Date: Jan. 31, 2013

(54) THIN PLASTIC CASING WITH DECORATIVE OUTER FILM AND MANUFACTURING METHOD THEREOF

(71) Applicant: Ming-Jen Hsieh, Taiping City (TW)

(72) Inventor: Ming-Jen Hsieh, Taiping City (TW)

(73) Assignee: PAO YI TECHNOLOGY CO., LTD., Taiping City, Taichung County (TW)

(21) Appl. No.: 13/639,500

(22) PCT Filed: Apr. 6, 2010
(86) PCT No.: PCT/CN2010/000438

§ 371 Date: Oct. 4, 2012

(51) Int. Cl. B32B 27/32; B29C 45/40; B32B 5/16

(52) U.S. Cl. 428/76; 264/161

(57) ABSTRACT

A thin plastic casing with a decorative outer film and a manufacturing method thereof are revealed. First provide an outer film that is a fabric layer or a leather layer. Then arrange a thermoplastic rubber (TPR) adhesive layer on an inner surface of the outer film. Next fix the outer film flatly in a cavity of an injection mold of a thin plastic casing while an outer periphery of the outer film is over an outer boundary of the cavity. Then inject the thin plastic casing to the TPR adhesive layer by plastic injection molding. The outer boundary of the cavity is over a boundary line of the thin plastic casing to form a thinner material overflow area. Cut the flash to get a thin plastic casing with a decorative outer film. Thus adhesion strength between the outer film and the thin plastic casing and product quality are improved.

### BACKGROUND OF THE INVENTION

1. Fields of the Invention

The present invention relates to a thin plastic casing and a manufacturing method thereof, especially to a thin plastic casing with a decorative outer film and a manufacturing method thereof in which a thermoplastic rubber (TPR) adhesive layer is disposed on an inner surface of a outer film and then a thin plastic casing is injected into the TPR adhesive layer by injection molding so as to form an closely-connected thin plastic casing with an integral composite structure. The outer film is a fabric layer formed by natural/artificial fiber, or a leather layer formed by polyurethane (PU), polyvinyl chloride (PVC), or PU together with PVC. The TPR adhesive layer is a thermoplastic rubber layer synthesized by butadiene-styrene block copolymer and hydrocarbon petroleum resin

2. Descriptions of Related Art

There are various electronics available on the market including, but not limited to, computers such as notebook computers, communication products such as mobile phones, consumer products (so-called 3C products), etc. They all include a thin casing used as a housing that covers all the components therein. The structure of the thin casing varies according to the design requirements of the product. According to materials for a base of the thin casing, the thin casing includes two types-a thin plastic casing and a metal thin casing.

The thin plastic casing with a decorative outer surface is generally produced by in-mold decoration process (IMD). A substrate that is 3-dimensional and printed with figures such as a plastic film is mounted into a mold. The substrate (plastic film) is called IMD film hereafter. Then thermoplastic resin is injected by plastic injection molding technique to form a base of the casing on the rear side of the IMD film and the base is called resin base. The resin base and the IMD film are connected to form an integral thin plastic casing. The IMD film is fixed and connected to the outer surface of the resin base to form a permanent device. The IMD film is used as a decorative outer surface for the thin plastic casing, a protective surface for the thin plastic casing or both. Moreover, the protective surface for the can also be temporarily fixed on the outer surface of the resin base to form a temporary device. After completing the production, the IMD film is peeled off. The printed figures on the IMD film are transferred to or embossed on the outer surface of the resin base to form a decorative outer surface of the thin plastic casing.

There are many techniques related to the structure design and manufacturing method of the thin plastic casing mentioned above.

Refer to U.S. Pat. No. 3,654,062, a molded decorative plaque including a body portion of a plastic material and a facing sheet disposed over the front face of the body portion is produced by injection molding. The thermoplastic is injected into a mold on a rear side of the facing sheet. As to U.S. Pat. No. 6,117,384, a printed substrate with at least one color is fit into a mold and then a molten resin is injected into the mold cavity through gates behind the printed substrate to produce a one-piece permanently bonded three-dimensional product. In the U.S. Pat. No. 4,391,954, a thermoplastic molding composition comprising an aromatic carbonate polymer and a polyester derived from a cycleohexanedimethanol is revealed. The U.S. Pat. No. 6,465,102 reveals an article that includes a formed polymeric base with a decorative surface area and a process for making the molded structure. The polymeric base comprises a transparent cycloaliphatic polyester resin that is free from an aromatic moiety and the method of molding thereof. In the U.S. Pat. No. 6,117,384, an improved in-mold decorating process (IMD) for the manufacture of plastic articles is disclosed while the U.S. Pat. No. 6,136,441 reveals techniques related to multilayer plastic articles. Refer to the patents that reveal structure design or manufacturing method related to the plastic housing mentioned above, it is learned that most of the techniques place a further limitation on the IMD film and the resin base respectively. For example, the IMD film or the resin base is restricted to be made from plastic with a specific chemical group. Thus an integral composite plastic board in which the film and the base are connected firmly and difficult to peel off is produced. Each patent is distinctive from other patents.

However, when the IMD film and/or the resin base of the thin plastic casing formed by composite materials are/is placed with a further limitation, not only the materials used are restricted, the applications of the IMD film and/or the resin base are also limited. This has negative effect on the applications of the produced thin plastic casing. For example, once users want to use different materials to produce the IMD film such as fabric, leather, resin fiber, etc for diversity of products, the same technique or equipment is unable to be used for manufacturing the products with high production efficiency, ease in mass production, and good quality control. Thus the use efficiency and applications of the plastic housing are unable to be improved. These are disadvantages of the thin plastic casing.

As to the common thin metal casing, it is generally produced by machining of a metal sheet such as aluminum alloy sheet. The thin metal casing can be further treated by surface processing to have gloss or patterns. Moreover, a protective resin layer such as resin film is arranged over the outer surface of the metal housing to avoid damages in use such as scratches, bumps, etc. Or a resin layer with figures is arranged at the outer surface of the metal housing for protecting and improving the appearance or texture of the product. For assembling components inside the product, plastic injection molding technique or injection molding attachment is used to dispose or attach various plastic components such as flange or rib on a certain position of an inner surface (metallic surface) of the thin metal casing. Thus the structure of these plastic components is simplified, the whole thickness is reduced and the structural strength is improved.

There are various techniques related to the structure design and manufacturing method of the thin metal casing mentioned above available now, including U.S. Pat. No. 5,695,699, No. 5,472,782, US Pub. No. US2009/0117401, US2008/0127479, US2007/0218721, etc.

Refer to Chinese Pat. App. No. ZL02805359.1 (PCT/JP2002/007267, WO2003/064150), a composite material of aluminum alloy and resin and a production method therefore are revealed. As a pre-treatment, a rib is immersed in at least one aqueous solution selected from ammonia, hydrazine, hydrazine derivative and water-soluble amine compound. Then the rib is inserted into an injection molding die used to inject it. A thermoplastic resin composition is filled in the surface of a metal frame by injection molding to form a rib. A molded cover enclosure includes integrally joined metal frame and ribs of a thermoplastic resin composition and having the features of metal in terms of strength and external design. Moreover, the interior of the enclosure can be produced with complicated shape and structure.

Refer to Chinese Pat. App. No. ZL200380102886.0 (PCT/JP2003/014213, WO2004/041532), a composite article of aluminum alloy with resin and a method for production thereof are revealed. The composite article includes a thermoplastic resin composition containing polyphenylene sulfide as a component and adhered to the surface of a shaped article of an aluminum alloy. The method includes a pretreatment comprising immersing the shaped article of an aluminum alloy in an aqueous solution of at least one selected from among ammonia, hydrazine and a water-soluble amine compound.

Refer to Chinese Pat. App. No. ZL200380104500.X (PCT/JP2003/014214, WO2004/041533), a composite of aluminum alloy and resin composition and a process for producing the same are revealed. The composite is characterized by comprising an aluminum alloy shaped item having a surface roughness of 5 to 50 μm or more, the surface provided with 1 μm or less fine depressions or protrusions, and a thermoplastic resin composition composed mainly of a polyphenylene sulfide or polybutylene terephthalate resin whose average of lengthwise and crosswise linear expansion coefficients is in the range of 2 to 4×10⁻⁵° C.⁻¹. The thermoplastic resin composition is penetrating and anchored in the depressions or protru0sions.

Refer to Chinese Pat. App. No. ZL200680046075.7 (PCT/JP2006/324493, WO2007/066742), an aluminum alloy-resin composite and a method of producing the same are revealed. The composite is formed by an aluminum alloy-based material and resin component. An aluminum alloy-based material is dipped in a corrosive aqueous solution such as ammonia, hydrazine, or water-soluble amine compounds to form microconcaves coating the surface. The average radius of the microconcaves is ranging from 10 nm to 80 nm. As the resin component, it includes polyamide resin compounded and a material having improved shock resistance. The aluminum alloy-based material is inserted into an injection molding die and the polyamide-based resin composition is injected onto the surface thereof to give an integrated composite product.

However, the above patents all relate to a composite material formed by metal and resin and a manufacturing method thereof and feature on that the metal (such as aluminum alloy) is immersed in a special aqueous solution (such as water-soluble amine). Then thermoplastic resin with specific ingredients is attached and integrated to a surface of the aluminum alloy by injection molding. In other words, the treatment of the metal (aluminum alloy) and the ingredients of the resin are both specified and restricted. Thus the manufacturing method and the application of the composite material are limited. This has negative effect on use efficiency and application of the metal housing. Especially most of the specific aqueous solution used doesn't match environmental requirements. The thin metal casings and manufacturing methods thereof mentioned above have following shortcomings: In the injection mold, a pouring opening is designed corresponding to each plastic part for performing injection under high pressure at fixed points. During the plastic injection molding process, the thin metal casing is easy to get deformed or damaged and the difficulty in manufacturing of the injection mold is increased. Moreover, the metal surface of the thin metal casing needs to be soaked in specific aqueous solution and this makes the manufacturing process more complicated and has negative effect on mass production of the thin metal casing. The specific aqueous solution also causes environmental problems.

As to Taiwanese Pat. App. No. 85100575 (Pub. No 404888), a metal sheet covered by resin and having high distinctness of image and excellent adhesion during processing is revealed. A metal sheet is used as a substrate and is covered by resin. At one side of the substrate, a coating layer, a modified acrylic resin layer with a thickness of 5˜100 μm, a patterned and/or printed layer, an adhesive layer, and a polyester-based resin film with a thickness of 5˜100 μm arranged in sequence therefrom (refer to claim 1). The modified acrylic resin layer is formed by polypropylene copolymer 100˜20 parts by weight and polypropylene 100˜0 parts by weight. Or the substrate is disposed with a coating layer, a patterned and/or printed layer, a modified acrylic resin layer with a thickness of 5˜100 μm, an adhesive layer, and a polyester-based resin film with a thickness of 5˜100 μm in turn (refer to claim 2). Or the substrate is installed with a coating layer, a modified acrylic resin layer with a thickness of 5˜100 μm, an adhesive layer, and a polyester-based resin film with a thickness of 5˜100 μm in turn (refer to claim 3). Or the substrate is set with a coating layer, a modified alkene layer with a thickness of 5˜100 μm, and a transparent polyester-based resin film with thickness of 5˜100 μm in sequence (refer to claim 4). However, the ingredients of the laminated resin layer have been specified and limited and the main purpose is to make the metal sheet covered by the resin have high distinctness of image. Thus the shape of the metal sheet is also limited and this has negative effect on the application of the metal housing produced by the metal sheet.

Refer to Taiwanese Pat. App. No. 86106332 (Pub. No. 434145) “metal sheet coated with resin and having higher definition, reflectivity and good adhesion”, a metal sheet covered with resin is revealed. The metal sheet covered with resin includes a metal sheet used as a base, a transparent soft resin layer, an adhesive layer with pigments, and a transparent resin film having two sides with gloss finish. The arithmetic mean deviation Ra of the roughness of the metal sheet is between 0 and 10 micrometers. The transparent soft resin layer can be uncured mixed type resin layer, coating cover layer made from polyester resin, or polyolefin resin. At least one surface of the metal sheet is covered by a coloring layer, the soft resin layer, the adhesive layer and the transparent layer in turn from the metal sheet to the transparent resin film. However, the ingredients of the resin coated the metal sheet are limited and the main purpose is to make the metal sheet covered by the resin have high reflectivity. Thus the shape of the metal sheet is also limited and this has negative effect on the application of the metal housing produced by the metal sheet.

Refer to Taiwanese Pat. App. No. 093119015 (Pat. Grant No. I280190) “method for forming electronic metal housing and structure of the same”, an aluminum alloy substrate disposed with a film layer focused on improvement of shortcomings of the above two prior arts is revealed. The method includes a step of coating adhesive, a step of firing and heating, a step of rolling and pressing and a step of cooling and forming. Firstly, coat adhesive on a surface of at least one side of a metal substrate made from aluminum alloy and the adhesive has metal powders. Then heat the metal substrate coated with the adhesive to make the adhesive become soft. A film layer is rolled and pressed over the adhesive by a heated roller. The film layer consists of at least one polyvinylchloride (PVC) layer, an adhesive layer, and a polyester layer laminated to each other in turn. The adhesive layer also includes metal powders. After cooling, the film layer and the metal substrate are connected to each other tightly. However, the ingredients of the film layer laminated on the surface of one side of the aluminum metal substrate including the PVC layer, the adhesive layer, and the polyester layer arranged in turn are specified and limited. Thus the shape of the metal substrate is restricted and this has negative effect on the application of the thin metal casing.

Refer to Taiwanese Pat. App. No. 093210282 (Pat. Grant No. M261368) “metal plate of electronic housing”, it also has shortcomings of restrictions on the film layer as mentioned in the above Taiwanese Pat. App. No. 093119015 (Pat. Grant No. I280190).

Refer to Taiwanese Pat. App. No. 097208521 (Pat. Grant No. M345706) “composite metal sheet”, a composite metal sheet including a metal substrate, a composite resin adhesive layer and a pressed layer laminated on a metal sheet over the composite resin adhesive layer. Thus the metal sheet and the metal substrate are connected with each other tightly. However, the two outer sides of this invention include the metal sheet and the metal substrate, both are being specified and restricted.

Refer to Taiwanese Pat. App. No. 096215339 (Pat. Grant No. M328384) “metal with environmental protection laminate”, the metal with the environmental protection laminate includes at least one metal substrate, an adhesive layer coated on at least one surface of one side of the substrate, and a film layer formed by a polyurethane (PU) bottom layer and a PU surface layer. The adhesive layer can be softened by being heated. A roller is used to roll and press the film layer on the adhesive layer. Then after cooling, the film layer and the metal substrate are connected firmly. However, the film layer formed by the PU bottom layer and the PU surface layer has been specified and defined. Thus the appearance or texture of the metal substrate is restricted and this is bad for the application of the metal housing produced by the metal with the film.

Thus the techniques available for composite boards have certain shortcomings. There is room for improvement and a need to provide a novel structure of a thin plastic casing and a method for manufacturing the same that overcomes the shortcomings of the prior arts including U.S. Pat. No. 3,654,062, U.S. Pat. No. 4,391,954, U.S. Pat. No. 6,465,102, U.S. Pat. No. 6,117,384, U.S. Pat. No. 6,136,44, etc. such as restrictions on the decorative outer film (plastic film/IMD film) and/or thin plastic casing (resin base) that reduces the selectivity of materials used and/or causes inconvenience in manufacturing processes.

### SUMMARY OF THE INVENTION

There it is a primary object of the present invention to provide a thin plastic casing with a decorative outer film and a manufacturing method thereof that overcomes the problems associated with the techniques available now.

In order to achieve the above object, a thin plastic casing with a decorative outer film of the present invention includes a an outer film, a thermoplastic rubber (TPR) adhesive layer, and a thin plastic casing. The outer film formed by a fabric layer or a leather layer with a certain thickness. A plurality of nearly evenly-distributed micro concave parts is arranged on an inner surface and an outer surface of the outer film. The micro concave parts are formed during manufacturing of the outer film. The TPR adhesive layer is a thermoplastic rubber layer synthesized by butadiene-styrene block copolymer and hydrocarbon petroleum resin with a thickness of 400-500 μm and is disposed on the inner surface of the outer film. The thin plastic casing is formed by plastic injection molding. The outer film disposed with the TPR adhesive layer is set and fixed in a cavity of an injection mold and then at least one injection material is injected into surface of the TPR adhesive layer on the inner surface of the outer film so as to form the thin plastic casing. The TPR adhesive layer is disposed between the outer film and the thin plastic casing produced by injection molding. The thin plastic casing and the TPR adhesive layer are melted and integrated with each other by injection pressure and temperature of the injection material during the injection molding. At the same time, a part of thickness of the TPR adhesive layer is forced to be infiltrated into the plurality of micro concave parts on the inner surface of the outer film. Thus the thin plastic casing and the outer film are connected by the TPR adhesive layer to form an integral composite structure.

The outer film is a fabric layer made from natural fiber such as vegetable fiber (cotton or hemp) or animal fiber (wool or silk). The outer film can also be a fabric layer made from artificial fiber such as nylon, polyester, acrylic fiber, or blends. Or the outer film is a synthetic leather layer formed by polyurethane (PU), polyvinyl chloride (PVC), or PU together with PVC.

The TPR adhesive layer is adhered to the inner surface of the outer film by hot pressing of a roller. About 10% of the TPR adhesive layer with a thickness of 400-500 μm, 40-50 μm, is infiltrated into the plurality of concave parts on the inner surface of the outer film during injection molding of the thin plastic casing.

The injection material for the thin plastic casing is selected from one of the followings or their combinations: acrylonitrile butadiene styrene (ABS), polycarbonate resin (PC), acrylic resin, and polyamide resin (nylon) or their combinations.

After the outer film disposed with the TPR adhesive layer being fixed in the cavity, an outer periphery of the outer film is over an outer boundary of the cavity of the injection mold of the thin plastic casing. A flash is formed on the thin plastic casing after the injection molding. The flash is a thinner material overflow area around a periphery of the injection mold and is formed due to that an outer boundary of the cavity is over a boundary line of the thin plastic casing.

In order to achieve the above object, a manufacturing method of a thin plastic casing with a decorative outer film according to the present invention includes following steps. Provide an outer film that is formed by a fabric layer or a leather layer with a certain thickness and having an inner surface and an outer surface thereof, both disposed with a plurality of evenly-distributed micro concave parts formed naturally during manufacturing of the outer film. Arrange a TPR adhesive layer with a thickness of 400-500 μm on the inner surface of the outer film while the TPR adhesive layer is a thermoplastic rubber layer synthesized by butadiene-styrene block copolymer and hydrocarbon petroleum resin. Then fix the outer film with the TPR adhesive layer in a cavity of an injection mold and inject at least one injection material into the TPR adhesive layer on the inner surface of the outer film to form a thin plastic casing by plastic injection molding. By injection pressure and temperature of the injection material during injection molding, the thin plastic casing and the TPR adhesive layer are melted and integrated with each other. At the same time, a part of the thickness of the TPR adhesive layer is forced to be infiltrated into the plurality of micro concave parts on the inner surface of the outer film. Thus the thin plastic casing and the outer film are connected by the TPR adhesive layer to form an integral composite structure. Remove the injection mold to get the thin plastic casing with the decorative outer layer after cooling. A flash is formed on the edge of the periphery of the thin plastic casing. Perform deflashing. Cut the flash along the periphery of the thin plastic casing to get a thin plastic casing with a decorative outer film.

After the outer film disposed with the TPR adhesive layer being fixed in the cavity, an outer periphery of the outer film is over an outer boundary of the cavity. A flash is formed by a thinner material overflow area around a periphery of the projection mold due to that the outer boundary of the cavity is over a boundary line of the thin plastic casing.

Compared with the techniques available now, the present invention has following advantages. By the pressure and temperature of the injection material during injection molding, the injected thin plastic casing is melted and connected to the TPR adhesive layer to form an integral composite structure. A part (about 10%) of the thickness of the TPR adhesive layer, 40-50 μm, is also forced to be infiltrated into the existing micro concave parts on the surface of the outer film. Thus the structural strength of the integral composite structure formed is improved. Moreover, a flash formed by the preset material overflow area is cut. Thus the quality of the periphery of the product is increased. Furthermore, the shortcomings of the technique available now such as IMD (in-mold decorating process) including melt, infiltration or damages of the fabric layer of the outer film due to high temperature or high pressure during injection molding can be avoided. The purposes of simple structure and better product quality are achieved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart showing steps of a method for manufacturing a thin plastic casing with a decorative outer film according to the present invention;

FIG. 2 is a perspective front view of an embodiment of a thin metal casing according to the present invention;

FIG. 3 is a schematic drawing showing a rear view of the embodiment in FIG. 2;

FIG. 4 is a partial enlarged view of a cross section of a thin plastic casing with a decorative outer film according to the present invention;

FIG. 5 is a schematic drawing showing a cross section of an injection mold according to the present invention;

FIG. 6 is a partial enlarged view of a cross section of an injection mold according to the present invention;

FIG. 7 is a schematic drawing showing a side view of an injection molding machine with three elastic pressure columns used as positioning points according to the present invention.

### DETAILED DESCRIPTION OF THE PREFERRED EMBODIMENT

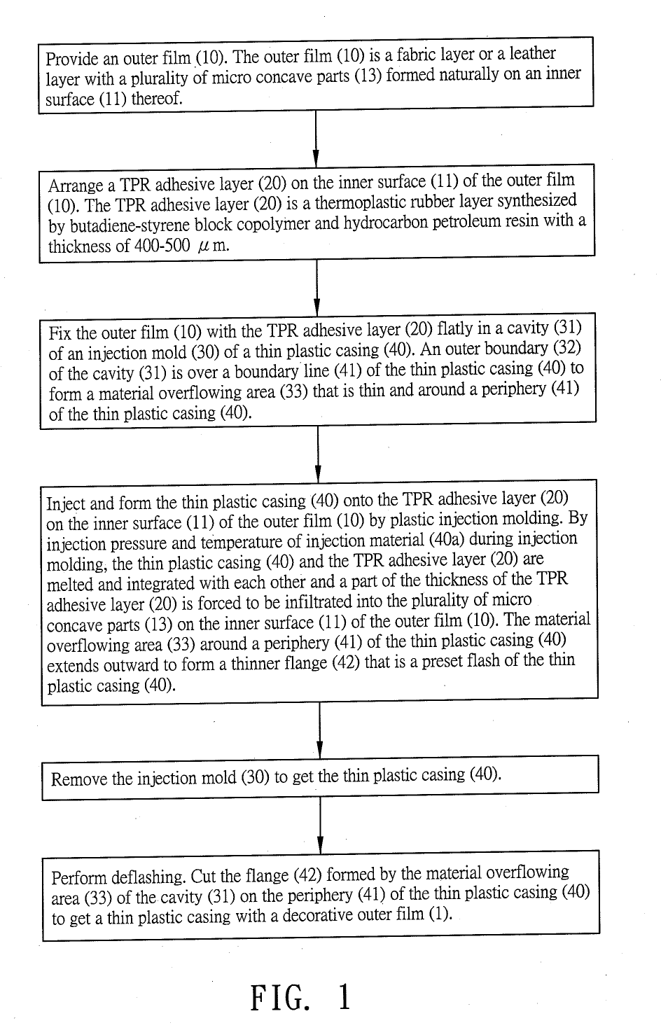

Refer from FIG. 1 to FIG. 4, a flow chart showing steps of a method for manufacturing a thin plastic casing with a decorative outer film, a perspective view and a cross sectional view of a thin plastic casing with a decorative outer film are revealed. A thin plastic casing with a decorative outer film 1 of the present invention mainly includes a decorative outer film 10, a TPR adhesive layer 20 and a thin plastic casing 40. Each step of a manufacturing method of the present invention is described in the followings and the structure thereof is also explained. The manufacturing method of the present invention includes following steps.

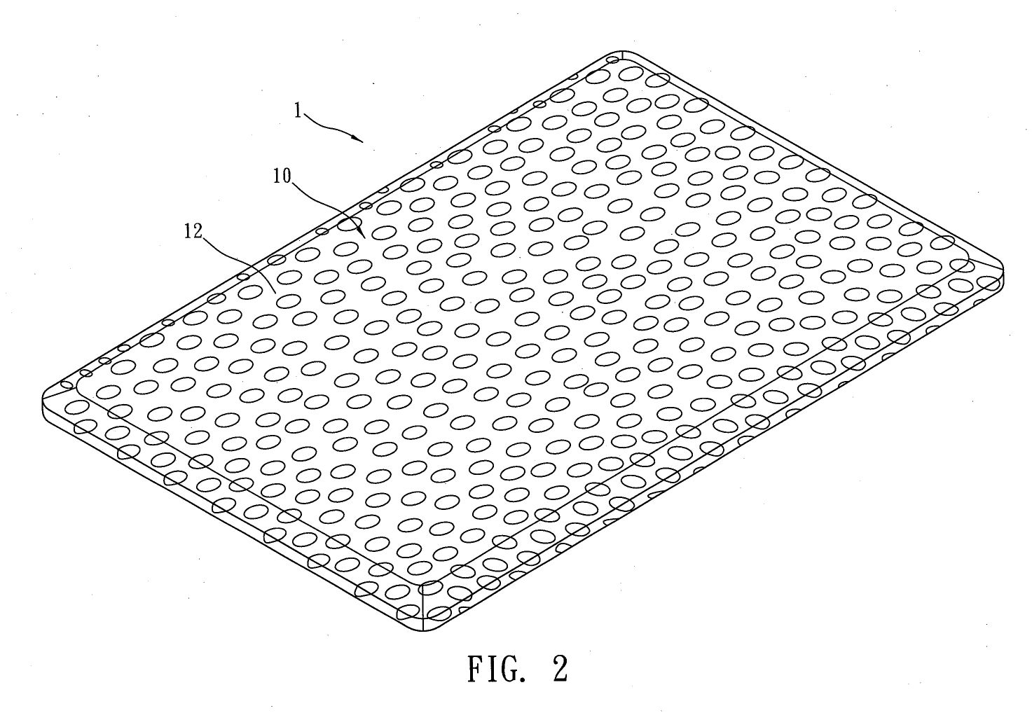

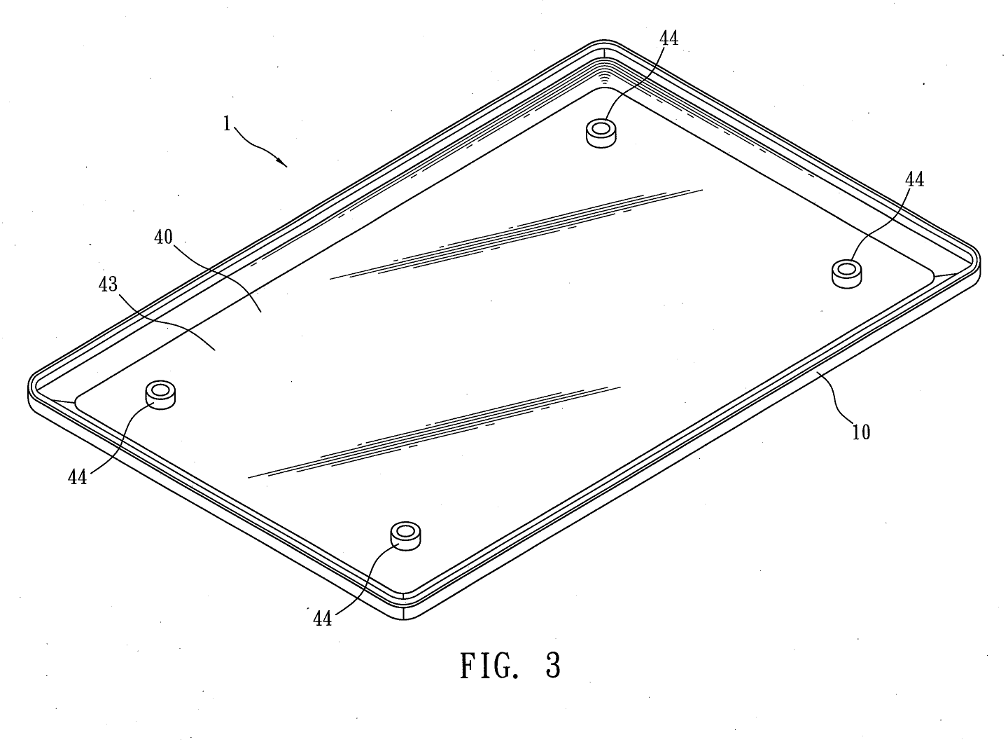

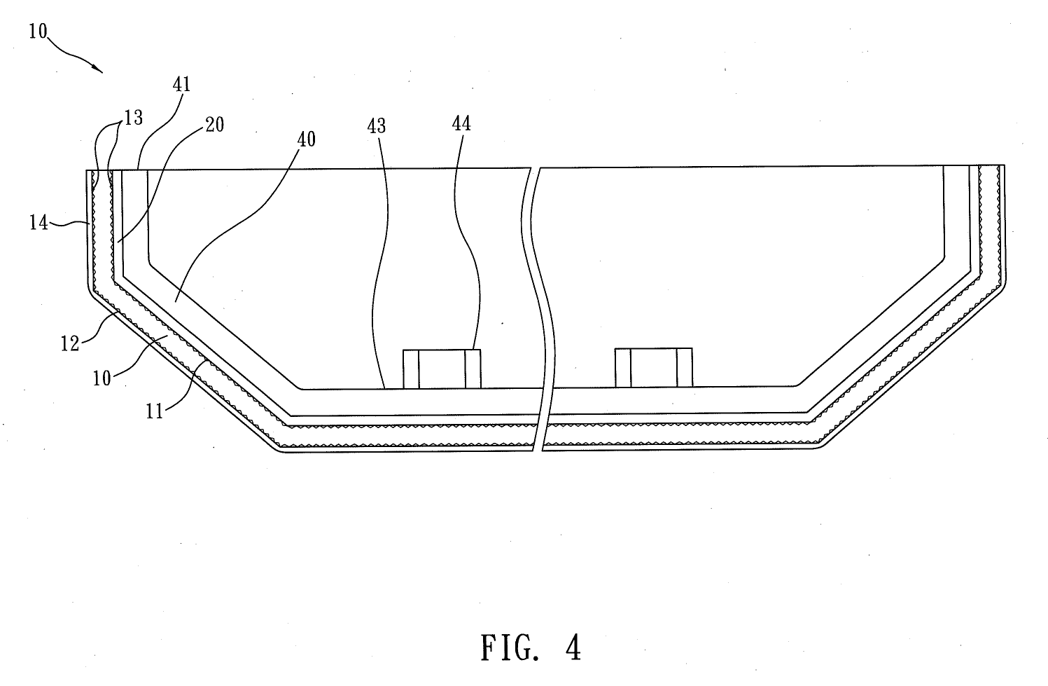

First provide a decorative outer film 10. The decorative outer film 10 of the present invention means a film layer used for decoration and disposed on surface of a housing of products. The products are, but not limited to, electronics including computers such as notebook computers, communication products or consumer products (3C products) etc. A thin plastic casing (housing) of a notebook computer is taken as an example, as shown in FIG. 2, FIG. 3 and FIG. 4. The decorative outer film 10 can be one of the followings or their combinations: a fabric layer, or a synthetic leather layer. The fabric layer is made from natural fiber such as vegetable fiber, animal fiber, or artificial fiber. The vegetable fiber can be cotton, hemp, the animal fiber can be wool, silk, etc. and the artificial fiber includes nylon, polyester, acrylic fiber, or blends. The synthetic leather layer is made from PU, PVC, or PU together with PVC. Moreover, an inner surface 11 and an outer surface 12 of the outer film 10 is naturally formed with a plurality of micro concave parts 13 during manufacturing process of the outer film 10 such as weaving process. The micro concave parts 13 are distributed quite evenly. The outer surface 12 of the outer film 10 can be further processed to have a transparent protection membrane 14 for protecting the outer surface 12, or changing gloss and the sense of touch of the outer surface 12. During the operation, the outer film 10 is produced into a long strip with a certain width and rolled into a roll. Under the guidance of a conveyor, the outer film 10 is pulled to a working platform of a machine to be cut into pieces used in following processes.

Then a TPR adhesive layer 20 with a thickness of 400-500 μm is arranged over the inner surface 11 of the outer film 10, where the plastic casing is injected thereto. The TPR adhesive layer 20 is a thermoplastic rubber layer synthesized by butadiene-styrene block copolymer and hydrocarbon petroleum resin. The disposition way of the TPR adhesive layer 20 is not limited. For example, the TPR adhesive layer 20 is laminated to the inner surface 11 of the outer film 10 by hot pressing of a roller. The outer film 10 coated with the TPR adhesive layer 20 has a certain degree of elongation. During the operation, the TPR adhesive layer 20 is produced into a long strip with a certain width and rolled into a roll. Under the guidance of a conveyor, the TPR adhesive layer 20 is pulled to a working platform of a machine to be cut into pieces with a certain area to be used together with the outer film 10.

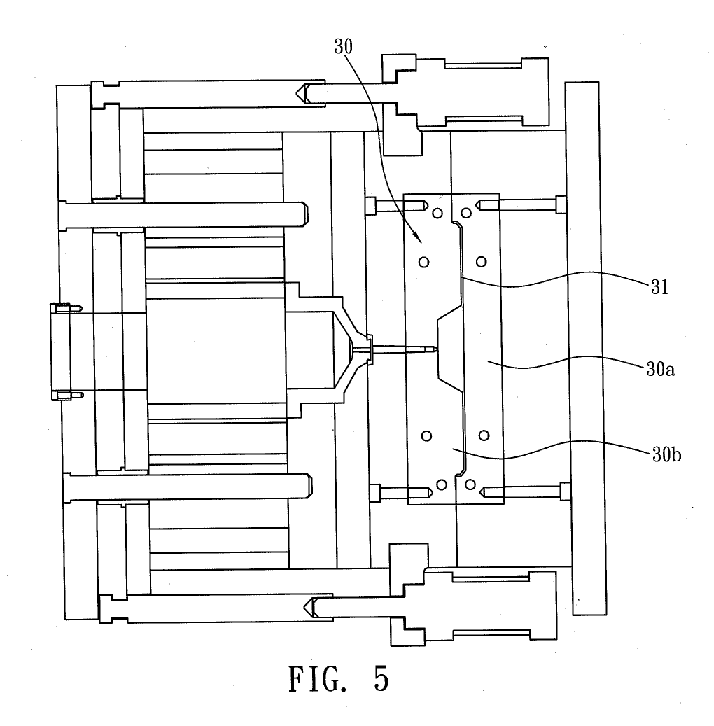

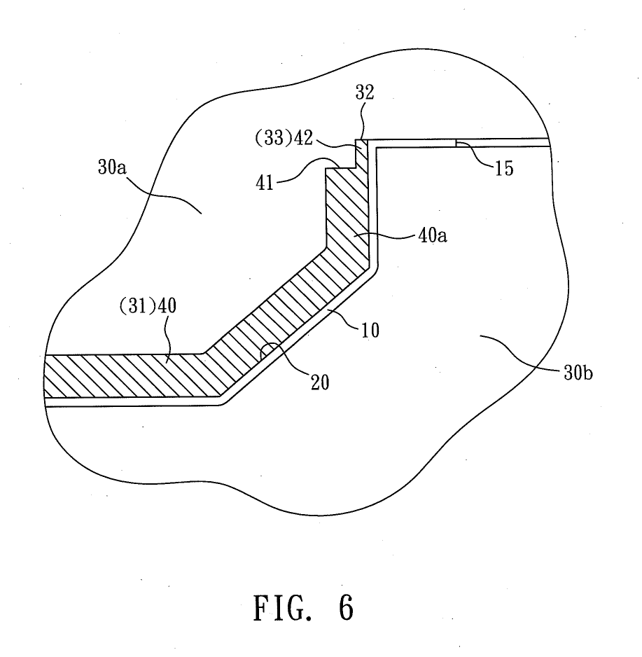

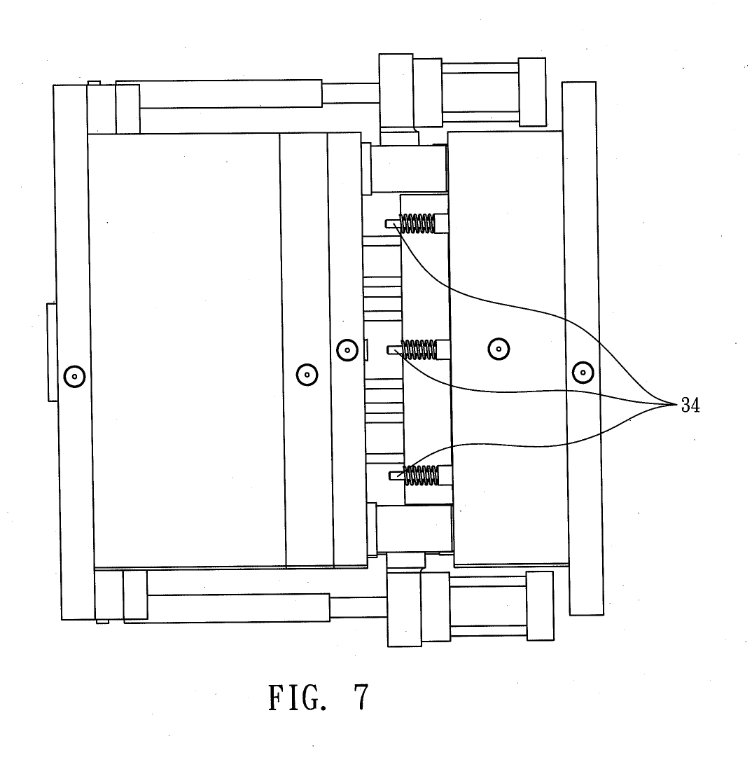

Later the outer film 10 disposed with the TPR adhesive layer 20 is fixed in a cavity 31 of an injection mold 30 of a thin plastic casing flatly, as shown in FIG. 5 and FIG. 6. The injection mold 30 is designed according to techniques related to plastic injection molding and there is no restriction on the arrangement of pouring openings and channels for conveying injection materials. After the outer film 10 with the TPR adhesive layer 20 being fixed into the cavity 31, an outer periphery 15 of the outer film 10 is over an outer boundary 32 of the cavity 31 while the outer boundary 32 of the cavity 31 is over a boundary line (or peripheral end surface) 41 of the thin plastic casing 40 to form a material overflow area 33 that is thin and around the injection mold 30. There is a drop height between the material overflow area 33 and the boundary line 41 of the thin plastic casing 40, as shown in FIG. 6. Moreover, refer to FIG. 7, a plurality of elastic pressure column 34 used as positioning points is arranged around a periphery of the cavity 31. The number of the elastic pressure columns 34 is not limited and there are three elastic pressure columns 34 on one side shown in FIG. 7. The edge of the outer film 10 is clipped and supported elastically by the plurality of elastic pressure columns 34 so as to keep the outer film 10 set in the cavity in a flat state without shrinkage or wrinkles while male/female molds 30a-30b being closed.

Next inject the thin plastic casing 40 to the TPR adhesive layer 20 on the inner surface 11 of the outer film 10 by plastic injection molding. By the injection pressure and temperature of injection materials 40a during injection molding, the thin plastic casing 40 and the TPR adhesive layer 20 are melted and integrated with each other. At the same time, a part of the thickness of the TPR adhesive layer 2, about 10%, is infiltrated into the existing micro concave holes 13 on the inner surface 11 of the outer film 10. Thus the thin plastic casing 40 and the inner surface 11 of the outer film 10 are attached and fixed to each other firmly to form an integral composite structure. Moreover, the material overflow area 33 is formed due to the outer boundary 32 that is over a boundary line (or peripheral end surface) 41 of the thin plastic casing 40. The material overflow area 33 extends outward from the boundary line 41 of the thin plastic casing 40 to form a thinner flange 42, as shown in FIG. 6. That means the thinner flange 42 is formed integrally on the edge of the injected thin plastic casing 40 before deflashing. The flange 42 is so-called flash that is going to be removed by following operations. Furthermore, if users intend to install electric components such as circuit board on an inner surface 43 of the injected thin plastic casing 40, connection parts 44 (as shown in FIG. 3) required for installation are also injected to and formed on the inner surface 43 of the thin plastic casing 40 while the thin plastic casing 40 being injected. Thus both the thin plastic casing 40 and the connection parts 44 are injected at the same time to form an integral structure.

After cooling, remove the injection mold 30 to get the thin plastic casing 40.

Then perform deflashing. That means to cut the flange 42 (shown in FIG. 6) formed by the material overflow area 33 along the boundary line 41 of the thin plastic casing 40 to produce a final product-the thin plastic casing with the decorative outer film 1, as shown from FIG. 2 to FIG. 4.

In the manufacturing method above, the TPR adhesive layer 20 is infiltrated into the existing micro concave holes 13 on the inner surface 11 of the outer film 10 and melted and integrated with the thin plastic casing 40. Thus adhesion and connection of the outer film 10 and the thin plastic casing 40 are quite good. After being tested, it is proved that the outer film 10 has sufficient peel resistance. The manufacturing method of the present invention can increase the structure strength of the integral composite structure.

The present invention features on the design of the thinner material overflow area 33 around the edge of the outer boundary 32 of the cavity 31. While being injected, the injection material 40a generally enters the cavity 31 through a center area of the cavity 31. That means the pouring opening is disposed on the center of the cavity 31. Then the injection material 40a flows radially and faster toward the outer boundary 32 of the cavity 31. That means while the injection material 40a flows from the center toward the outer boundary 32, it also presses the outer film 10 on the outer boundary 32 so that the flowing of the injection material 40a forces the outer film 10 on the outer boundary 32 to extend outward. Thus a straightening effect from inward to outward is generated and is extended to the material overflow area 33, the outer boundary of the cavity 31. Thus the outer film 10 around the thinner flange 42 on the edge of the injected thin plastic casing 40 is getting more dense and straightened. After the flange 42 (flash) being removed, the periphery of the product is more flat and the product quality is improved.

In the present invention, the injection molding of the thin plastic casing 40 is performed after the TPR adhesive layer 20 being disposed on the inner surface 11 of the outer film 10. The outer film 10 can be made from various materials such as a fabric layer, or a synthetic leather layer. The fabric layer is made from natural or artificial fiber and the synthetic leather layer is made from PU, PVC, or PU together with PVC. And the thin plastic casing 1 with good quality is produced by plastic injection molding and the manufacturing processes are simplified.

In the manufacturing processes mentioned above, when the thin plastic casing 40 is injected to TPR adhesive layer 20 on the inner surface 11 of the outer film 10 by plastic injection molding, the injection materials 40a for the thin plastic casing 40 can be various plastics such as acrylonitrile butadiene styrene (ABS), polycarbonate resin (PC), acrylic resin, polyamide resin (nylon), etc. The pressure and temperature of the injection materials 40a are as followings: 80 kg/mm² and 200° C. for ABS, 120 kg/mm² and 260° C. for PC, 100 kg/mm² and 240° C. for acrylic resin and 80 kg/mm² and 260° C. for nylon.

The structure and functions of a thin plastic casing with a decorative outer film of the present invention are further described in details by following embodiments.

### Embodiment One

In the thin plastic casing 1 of this embodiment, the outer film 10 is made from artificial fiber such as nylon, polyester, acrylic fiber, etc. with a thickness of 0.55 mm and the TPR adhesive layer 20 is a thermoplastic rubber layer synthesized by butadiene-styrene block copolymer and hydrocarbon petroleum resin with a thickness of 400-500 μm. The TPR adhesive layer is attached to the inner surface 11 of the outer film 10 by hot pressing. The injection material 40a for the thin plastic casing 40 is PC (polycarbonate resin) and is injected to the TPR adhesive layer 20 on the inner surface 11 of the outer film 10 by plastic injection molding to form the thin plastic casing 40. The thickness of the thin plastic casing 40 is 2 mm while the length and width thereof are respectively 262 mm and 178 mm. Moreover, the inner surface 11 is arranged with a plurality of connection parts 44 that are formed integrally with the thin plastic casing 40 and with the height of 9.5 mm. After being tested, the peel strength adhesion between the outer film 10 and the thin plastic casing 40 of this embodiment is 8 kg/cm². In the environmental testing with adhesion testing, the operating temperature is increasing/decreasing 1° C. each min from −40° C. to 85° C./from 85° C. to −40° C. and there are four cycles. The outer film 10 is not peeled off from the thin plastic casing 40.

### Embodiment Two

In the thin plastic casing 1 of this embodiment, the outer film 10 is synthetic leather layer made from PU (polyureathane) with a thickness of 0.55 mm. The TPR adhesive layer 20 is a thermoplastic rubber layer synthesized by butadiene-styrene block copolymer and hydrocarbon petroleum resin with a thickness of 400-500 μm. The TPR adhesive layer 20 is attached to the inner surface 11 of the outer film 10 by hot pressing. The injection material 40a for the thin plastic casing 40 is PC (polycarbonate resin) and is injected to the TPR adhesive layer 20 on the inner surface 11 of the outer film 10 by plastic injection molding to form the thin plastic casing 40. The thickness of the thin plastic casing 40 is 2 mm while the length and width thereof are respectively 262 mm and 178 mm. Moreover, the inner surface 11 is arranged with a plurality of connection parts 44 that are formed integrally with the thin plastic casing 40 and with the height of 9.5 mm. After being tested, the peel strength adhesion between the outer film 10 and the thin plastic casing 40 of this embodiment is 8 kg/cm². In the environmental testing with adhesion testing, the operating temperature is increasing/decreasing 1° C. each min from −40° C. to 85° C./from 85° C. to −40° C. and there are four cycles. The outer film 10 and the thin plastic casing 40 are not peeled from each other.

### Embodiment Three

In the thin plastic casing 1 of this embodiment, the outer film 10 is a fabric layer made from the artificial fiber includes nylon, polyester, acrylic fiber, or blends with a thickness of 0.55 mm. The TPR adhesive layer 20 is a thermoplastic rubber layer synthesized by butadiene-styrene block copolymer and hydrocarbon petroleum resin with a thickness of 400-500 μm. The TPR adhesive layer 20 is attached to the inner surface 11 of the outer film 10 by hot pressing. The injection material 40a for the thin plastic casing 40 is ABS (acrylonitrile butadiene styrene) and is injected to the TPR adhesive layer 20 on the inner surface 11 of the outer film 10 by plastic injection molding to form the thin plastic casing 40. The thickness of the thin plastic casing 40 is 2 mm while the length and width thereof are respectively 262 mm and 178 mm. Moreover, the inner surface 11 is arranged with a plurality of connection parts 44 that are formed integrally with the thin plastic casing 40 and with the height of 9.5 mm. After being tested, the peel strength adhesion between the outer film 10 and the thin plastic casing 40 of this embodiment is 8 kg/cm². In the environmental testing with adhesion testing, the operating temperature is increasing/decreasing 1° C. each min from −40° C. to 85° C./from 85° C. to −40° C. and there are four cycles. The outer film 10 and the thin plastic casing 40 are not peeled from each other.

### Embodiment Four

In the thin plastic casing 1 of this embodiment, the outer film 10 is synthetic leather layer made from PU (polyureathane) with a thickness of 0.55 mm. The TPR adhesive layer 20 is a thermoplastic rubber layer synthesized by butadiene-styrene block copolymer and hydrocarbon petroleum resin with a thickness of 400-500 μm. The TPR adhesive layer 20 is attached to the inner surface 11 of the outer film 10 by hot pressing. The injection material 40a for the thin plastic casing 40 is ABS (acrylonitrile butadiene styrene) and is injected to the TPR adhesive layer 20 on the inner surface 11 of the outer film 10 by plastic injection molding to form the thin plastic casing 40. The thickness of the thin plastic casing 40 is 2 mm while the length and width thereof are respectively 262 mm and 178 mm. Moreover, the inner surface 11 is arranged with a plurality of connection parts 44 that are formed integrally with the thin plastic casing 40 and with the height of 9.5 mm. After being tested, the peel strength adhesion between the outer film 10 and the thin plastic casing 40 of this embodiment is 8 kg/cm². In the environmental testing with adhesion testing, the operating temperature is increasing/decreasing 1° C. each min from −40° C. to 85° C./from 85° C. to −40° C. and there are four cycles. The outer film 10 and the thin plastic casing 40 are not separated from each other.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A thin plastic casing with a decorative outer film comprising: an outer film, a thermoplastic rubber (TPR) adhesive layer, and a thin plastic casing; wherein
the outer film formed by a fabric layer or a leather layer with a certain thickness and having an inner surface and an outer surface thereof, both disposed with a plurality of evenly-distributed micro concave parts formed naturally during manufacturing of the outer film;
the TPR adhesive layer is a thermoplastic rubber layer synthesized by butadiene-styrene block copolymer and hydrocarbon petroleum resin with a thickness of 400-500 μm and is disposed on the inner surface of the outer film; the thin plastic casing is formed by plastic injection molding;
the outer film disposed with the TPR adhesive layer is set and fixed in a cavity of an injection mold and then at least one injection material is injected to surface of the TPR adhesive layer on the inner surface of the outer film so as to form the thin plastic casing,
wherein the TPR adhesive layer is disposed between the outer film and the thin plastic casing formed by the injection molding; wherein the thin plastic casing and the TPR adhesive layer are melted and integrated with each other by injection pressure and temperature of the injection material during the injection molding; simultaneously a part of thickness of the TPR adhesive layer is forced to be infiltrated into the plurality of micro concave parts on the inner surface of the outer film so that the thin plastic casing and the outer film are connected by the TPR adhesive layer to form an integral composite structure.

2. The device as claimed in claim 1, wherein the outer film is a fabric layer made from natural fiber including vegetable fiber such as cotton, hemp, or animal fiber such as wool, silk.

3. The device as claimed in claim 1, wherein the outer film is a fabric layer made from artificial fiber including nylon, polyester, acrylic fiber, and blends.

4. The device as claimed in claim 1, wherein the outer film is a synthetic leather layer formed by polyurethane (PU), polyvinyl chloride (PVC), or PU together with PVC.

5. The device as claimed in claim 1, wherein the TPR adhesive layer is attached to the inner surface of the outer film by hot pressing of a roller.

6. The device as claimed in claim 1, wherein about 10% of the TPR adhesive layer with a thickness of 400-500 μm, 40-50 μm, is infiltrated into the plurality of concave parts on the inner surface of the outer film during the injection molding of the thin plastic casing.

7. The device as claimed in claim 1, wherein the injection material for the thin plastic casing is selected from one of the group consisting of: acrylonitrile butadiene styrene (ABS), polycarbonate resin (PC), acrylic resin, and polyamide resin (nylon) or their combinations.

8. The device as claimed in claim 1, wherein after the outer film disposed with the TPR adhesive layer being set and fixed in the cavity of the injection mold, an outer periphery of the outer film is over an outer boundary of the cavity of the injection mold of the thin plastic casing.

9. The device as claimed in claim 1, wherein a flash is formed on the thin plastic casing after the injection molding; the flash is a thinner material overflow area around a periphery and is formed because that an outer boundary of the cavity is over a boundary line of the thin plastic casing.

10. A manufacturing method of a thin plastic casing with a decorative outer film as claimed in claim 1 comprising the steps of:
providing an outer film that is formed by a fabric layer or a leather layer with a certain thickness and having an inner surface and an outer surface thereof, both disposed with a plurality of nearly evenly-distributed micro concave parts formed naturally during manufacturing of the outer film;
arranging a TPR adhesive layer with a thickness of 400-500 μm on the inner surface of the outer film; the TPR adhesive layer is a thermoplastic rubber layer synthesized by butadiene-styrene block copolymer and hydrocarbon petroleum resin;
fixing the outer film with the TPR adhesive layer in a cavity of an injection mold and injecting injection material into the TPR adhesive layer on the inner surface of the outer film to form a thin plastic casing by injection molding; the thin plastic casing and the TPR adhesive layer are melted and integrated with each other by injection pressure and temperature of the injection material during the injection molding and a part of the thickness of the TPR adhesive layer is also forced to be infiltrated into the plurality of micro concave parts on the inner surface of the outer film so as to connect the thin plastic casing and the outer film by the TPR adhesive layer and form an integral composite structure;
removing the injection mold to get a thin plastic casing with a decorative outer film after cooling while a flash is formed on edge of a boundary line of the thin plastic casing; and
performing deflashing by cutting the flash on the boundary line 5 of the thin plastic casing to get the thin plastic casing with the decorative outer film.

11. The method as claimed in claim 1, wherein after the outer film disposed with the TPR adhesive layer being set and fixed in the cavity of the injection mold, an outer periphery of the outer film is over an outer boundary of the cavity.

12. The method as claimed in claim 1, wherein the flash is formed by a thinner material overflow area around a periphery of the cavity that is formed due to an outer boundary of the cavity is over a boundary line of the thin plastic casing.
